(19) United States
(12) Patent Application Publication
(10) Pub. No.: US 2022/0021849 A1
(43) Pub. Date: Jan. 20, 2022

(54) SMART PHOTO-MICROSCOPE SYSTEM

(71) Applicant: CARL ZEISS MICROSCOPY GMBH, Jena (DE)

(72) Inventors: Shukuan XU, Shanghai (CN); Luying QIANG, Shanghai (CN); Weiqiang GUO, Shanghai (CN); Lei CAI, Shanghai (CN); Zheng WAN, Shanghai (CN); Hexin WANG, Koenigsbronn (DE); Michael GOEGLER, Wolfratshausen (DE)

(21) Appl. No.: 17/295,987

(22) PCT Filed: Nov. 22, 2019
(86) PCT No.: PCT/CN2019/120356

§ 371 Date: May 21, 2021

(30) Foreign Application Priority Data
Nov. 22, 2018 (CN) 201821932903.3

(51) Int. Cl. H04N 7/18; H04N 5/232; G02B 21/36

(52) U.S. Cl. CPC H04N 7/183; G02B 21/361; H04N 5/23229; H04N 5/232933

(57) ABSTRACT

The invention relates to a smart photo-microscope system, including a microscope and a camera attached to the microscope to photograph a microscope sample. In an exemplary configuration, the camera includes a built-in processor and is connected with the microscope to receive and process information from the microscope. In another exemplary configuration, the smart photo-microscope system further includes a single board computer (SBC), which includes a built-in processor and is connected with the microscope and camera to receive and process information from the microscope and/or camera.

### TECHNICAL FIELD

The invention relates to the photo-microscopy field, and more particularly to a smart photo-microscope system.

### BACKGROUND ART

Microscopes are used in many disciplines such as medicine, biology but also industry. Efficiency, ease of use, and price are main drivers, especially for users of routine microscopes. A large portion of commonly used microscope systems are manual microscopes in a price range of several thousand euros. Also in this microscope class, digital documentation is becoming increasingly important in routine microscopy. Very often users only want to take an image of the visualized sample quickly. However, even such a “simple” task can be cumbersome and error-prone on manual microscopes, since one has to adjust/define certain settings on the camera and/or microscope. Users typically have to define the magnification and the fluorescence channel they currently use when an image is acquired. Furthermore they have to use a proper white balance and set the exposure time and other parameters on the camera which affect the image. This also includes the gamma value, contrast or brightness.

For the photo-microscope system mentioned above, it is usually necessary to buy a computer (especially, PC) and additional software to drive a camera and/or the microscope, which can substantially add to the costs of the whole microscope system. Current commercial photo-microscope systems on the market need to install software on a computer that is hooked up to a microscope and camera (and maybe other devices/accessories). The software is then in control or receives information of the different parts of the photo-microscope system.

For motorized microscopes, the camera is merely an image collection device. Both the microscope and the camera are simultaneously connected to a PC, which is used as a control interface: the microscope sends data to the PC, the camera sends image data to the PC, while the PC analyzes the data, generates a shading corrected image with a scale bar, for example, and outputs the image to the user. The PC may also send commands, such as those for auto-focusing and panning, to the camera and microscope.

In case of manual microscopes, the software (computer) is only connected to and controls the camera, while is not connected to the microscope. Here one still has to provide necessary parameters (like magnification) manually and a separate computer is also required.

Apart from the additional costs, the footprint of a photo-microscope system also increases significantly due to the need for computer and software. However, in working environment doing routine microscopy, space is often extremely limited. Therefore, a big portion of photo-microscope users are looking for compact microscope system solutions that allow them to document their samples with high ease of use without disturbing their general workflow. They also expect that such a system prevents errors and comes at an affordable price.

### SUMMARY OF THE INVENTION

The invention aims to solve one or more of the above and other problems in the prior art.

According to a first aspect of the invention, a smart photo-microscope system is provided which comprises: A smart photo-microscope system, comprising: a microscope; and a camera attached to the microscope to photograph a microscope sample, the camera including a built-in processor and an image sensor, and being connected with the microscope to receive and process information from the microscope.

According to an exemplary configuration of the above first aspect, the camera is connected with the microscope to exchange therewith information used to operate the microscope and/or camera.

According to an exemplary configuration of the above first aspect, the camera is mounted outside or inside a housing of the microscope.

According to an exemplary configuration of the above first aspect, the built-in processor is an embedded processor.

According to an exemplary configuration of the above first aspect, the smart photo-microscope system further comprises a monitor in connection with the camera.

According to an exemplary configuration of the above first aspect, smart photo-microscope system further comprises a monitor with an On-Screen-Display (OSD) system, the monitor being connected with the camera to display the interaction between the camera and the microscope and/or display a Graphic User Interface (GUI) for controlling the camera and/or microscope.

According to an exemplary configuration of the above first aspect, the camera is connected with the microscope through a USB bus so as to exchange the information with the microscope and/or supply power to the camera from the microscope.

According to an exemplary configuration of the above first aspect, the information includes commands for controlling light sources and/or commands for controlling electric stage sent from the camera to the microscope and/or objective encoding information and/or reflector encoding information sent from the microscope to the camera.

According to an exemplary configuration of the above first aspect, the camera is configured to acquire magnification of the microscope, and/or an image with a scale bar, and/or a multi-channel fluorescence image and/or a single-channel fluorescence image.

According to an exemplary configuration of the above first aspect, raw image data acquired by the image sensor are processed by the built-in processor to enhance the image quality.

According to an exemplary configuration of the above first aspect, the camera is configured to detect the contrast method used according to condenser position and/or reflector position and/or light source used of the microscope.

According to an exemplary configuration of the above first aspect, the OSD system is configured to set and acquire image-related parameters and/or rename image files.

According to an exemplary configuration of the above first aspect, the smart photo-microscope system is connectable with a mouse and/or a keyboard and/or a storage device.

According to an exemplary configuration of the above first aspect, the smart photo-microscope system is connected with the mouse and/or the keyboard and/or the storage device via a USB hub.

According to an exemplary configuration of the above first aspect, the camera is configured to send an autofocus command to the microscope before an image is taken to generate a sharp camera image, and go back to the original focusing condition before the autofocus after the image is taken.

According to a second aspect of the invention, a smart photo-microscope system is provided which comprises: a microscope; a camera attached to the microscope to photograph a microscope sample and including an image sensor; and a single board computer (SBC) which includes a built-in processor and is connected with the microscope and camera to receive and process information from the microscope and/or camera.

According to an exemplary configuration of the above second aspect, the SBC is connected with the microscope and camera to exchange therewith information used to operate the microscope and/or camera.

According to an exemplary configuration of the above second aspect, the camera is mounted outside or inside a housing of the microscope.

According to an exemplary configuration of the above second aspect, the built-in processor is an embedded processor.

According to an exemplary configuration of the above second aspect, the smart photo-microscope system further comprises a monitor in connection with the SBC.

According to an exemplary configuration of the above second aspect, the smart photo-microscope system further comprises a monitor with an On-Screen-Display (OSD) system, the monitor being connected with the SBC to display the interaction between the camera and the microscope through the SBC and/or display a Graphic User Interface (GUI) for controlling the camera and/or microscope.

According to an exemplary configuration of the above second aspect, the SBC is connected with the microscope through a USB bus so as to exchange the information with the microscope and/or supply power to the SBC from the microscope.

According to an exemplary configuration of the above second aspect, the information includes commands for controlling light sources and/or commands for controlling electric stage sent from the SBC to the microscope and/or objective encoding information and/or reflector encoding information sent from the microscope to the SBC.

According to an exemplary configuration of the above second aspect, the camera is configured to acquire, through the SBC, magnification of the microscope, and/or an image with a scale bar, and/or a multi-channel fluorescence image and/or a single-channel fluorescence image.

According to an exemplary configuration of the above second aspect, raw image data acquired by the image sensor are processed by the built-in processor of the SBC to enhance the image quality.

According to an exemplary configuration of the above second aspect, the SBC is configured to detect the contrast method used according to condenser position and/or reflector position and/or light source used of the microscope.

According to an exemplary configuration of the above second aspect, the OSD system is configured to set and acquire image-related parameters and/or rename image files.

According to an exemplary configuration of the above second aspect, the smart photo-microscope system is connectable with a mouse and/or a keyboard and/or a storage device.

According to an exemplary configuration of the above second aspect, the smart photo-microscope system is connected with the mouse and/or the keyboard and/or the storage device via a USB hub.

According to an exemplary configuration of the above second aspect, the SBC is configured to send an autofocus command to the microscope before an image is taken to generate a sharp camera image, and go back to the original focusing condition before the autofocus after the image is taken.

According to an exemplary configuration of the above second aspect, the SBC includes one or more PCBs on which the built-in processor is mounted and which are positioned within a box outside the camera and microscope or are incorporated inside the microscope.

The smart photo-microscope system according to the invention, which uses a processor built in the camera or in a simple SBC to smartly control the camera and/or microscope, has at least the following advantages: there is no need to provide an additional separate computer and additional software, and less cables are used, so that space and costs can be saved; it is possible to reduce errors and increase efficiency for operations of acquiring and saving sample images in the microscope; settings of the camera and/or microscope can be adjusted and examined easily and quickly; ease of use and convenience are improved significantly compared to use of stand-alone cameras and computers.

### BRIEF DESCRIPTION OF THE DRAWINGS

The above and other advantages, features and details of the invention can be obtained through the following description of embodiments thereof with reference to the drawings.

FIG. 1 is a schematic block diagram of the smart photo-microscope system according to a first embodiment of the invention.

FIG. 2 is a construction view of components of the smart photo-microscope system as shown in FIG. 1.

FIG. 3 is a schematic block diagram of the smart photo-microscope system according to a second embodiment of the invention.

### DETAILED DESCRIPTION OF THE EMBODIMENTS

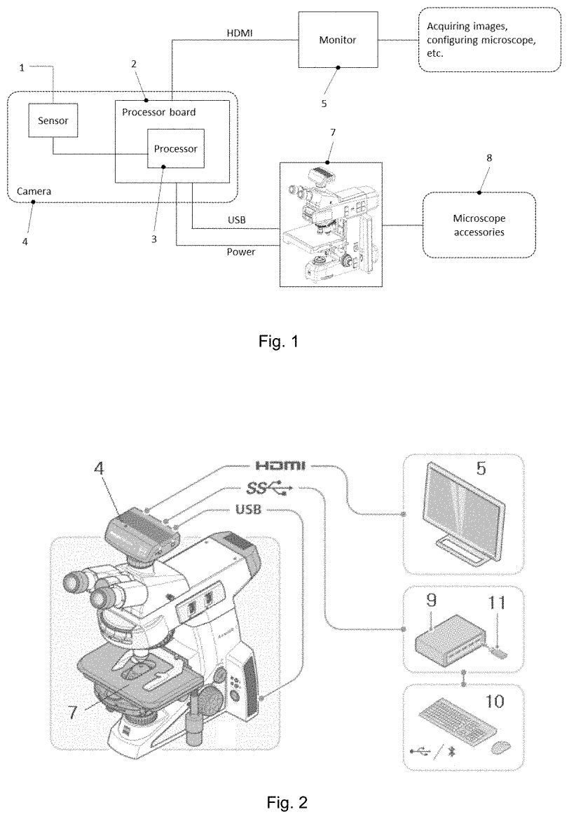

FIG. 1 shows a schematic block diagram of the smart photo-microscope system according to a first embodiment of the invention. The smart photo-microscope system includes a microscope 7 and a camera 4. The camera 4 may be attached to the microscope 7 as shown in FIG. 2 to photograph a microscope sample. The camera 4 may be mounted outside or inside a housing of the microscope 7 which may be of various types, e.g. an upright microscope, an inverted microscope or a stereo microscope. The camera 4 includes a built-in processor 3 which may be mounted on e.g. a processor board 2 that is built in the camera 4 and which may be e.g. an embedded processor. The camera 4 may be connected with the microscope 7 via the processor board 2 to receive and process information from the microscope 7, for example, exchange with the microscope 7 information used to operate the microscope 7 and/or camera 4. Such a connection may be achieved through a USB bus, such that not only information can be exchanged between the camera 4 and the microscope 4, but also the microscope 7 can supply power to the camera 4. Nevertheless, any means of communication that is able to exchange information may be used for the connection between the camera 4 and the microscope 7, such as Bluetooth, WIFI, etc. It may also be conceived that separate power supplies are used for the microscope 7 and camera 4, respectively.

The camera 4 may include an image sensor 1 to achieve its basic function of taking photos and/or videos. The image sensor is able to sense the images of a microscope sample, and may be e.g. a CMOS sensor. The image information acquired by the image sensor 1 is sent to the built-in processor 3, in which the raw image data from the image sensor 1 are processed to enhance the image quality (e.g. HDR, auto-exposure, auto-white balance etc.).

On the other hand, the built-in processor 3 is in communication with the microscope 7 by way of the above connection between the camera 4 and the microscope 7 so as to exchange information. Certain parameters of the microscope 7 may be set by the information sent from the built-in processor 3 of the camera 4 to the microscope 7. Meanwhile, the built-in processor 3 can receive and process information sent from the microscope 7 to the camera 4. For example, the microscope 7 may include microscope accessories 8, such as light source, electric stage, objective encoder, reflector encoder, motorization, condenser encoder and contrast encoder. Correspondingly, the information may include commands for controlling the light sources and/or commands for controlling the electric stage and/or position parameters for controlling operation of the microscope motor sent from the camera 4 to the microscope 7, and/or objective encoding information and/or reflector encoding information (e.g. the current position and type of the reflector) and optionally condenser encoding information or contrast encoding information (to detect the current contrast method) sent from the microscope 7 to the camera 4. In this way, the microscope 7 can be controlled from the camera 4, to switch light sources and perform other automatic functions, such as one-key multi-channel fluorescence imaging. The contrast method used, e.g. phase contrast or DIC, can be detected, e.g. via condenser position or in case of fluorescence e.g. via the reflector position in combination with the light source used. The camera can recognize this information and apply certain image processing functions to enhance image quality or to present the image in a user-friendly or commonly accepted mode. In the instance of a fluorescence image, the system would detect the fluorescence filter introduced, e.g. dual filter for DAPI and FITC fluorophore, and the fluorescence illumination light source wavelength used, e.g. 470 nm. A color camera used could then switch from RGB mode to Mono mode, take an image and apply a false color (e.g. green) to the image. In a similar way, images taken in phase contrast could be processed and presented differently to the user than pure brightfield images.

Users doing routine microscopy often sit several hours in front of the microscope looking through the oculars/eyepieces to investigate samples. It feels almost like a distraction when they want to acquire an image of the sample because they have to take their eyes of the microscope and look at a computer screen displaying the live image and some software. Here they have to make sure the image is in focus before they acquire it. In practice, it happens quite often that the camera image of a microscope system is not completely at the same focus level as the image in the ocular view. Therefore, if the ocular image is focused nicely, the camera image is often not perfectly focused.

With regards to motorized functions the camera can send commands to execute a positional change of some components to facilitate certain tasks for the user. For example: to address the aforementioned problem, the focus drive (z-position) might change its position automatically before/during an image is acquired, in order to snap a sharp image (e.g. autofocus). The user would then not necessarily have to refocus the camera image by himself when an acquisition is done. With a convenient method to initiate an image acquisition, e.g. a snap button on the microscope, the user might not even have to take his eyes of the microscope at all. The camera could even read the current z-focus position before an image acquisition is initiated (ocular image in focus), perform an autofocus routine for the camera image, snap the image, and return to previously used z-focus value (delivering again an in focus ocular image).

As shown in FIGS. 1 and 2, in order to facilitate setting of the microscope 7 and/or camera 4, the smart photo-microscope system according to the invention is further provided with a monitor 5, such as a display screen, which is connectable with the camera 4, so as to e.g. optionally display an On-Screen Display (OSD) system generated by the camera 4, i.e. a Graphic User Interface (GUI) for controlling the camera 4 and/or microscope 7. The monitor 5 is connected with the camera 4 (more precisely, the built-in processor 3 mounted on the processor board 2) via e.g. HDMI so as to display the OSD system, and/or display the interaction between the camera 4 and the microscope 7. What is interacted between the GUI and the camera 4 and/or microscope 7 may include image acquisition parameters of the camera 4, and/or system settings of the microscope 7 and/or camera 4, and/or images acquired by the camera 4. That is, by way of the OSD system, the user may set and acquire image-related parameters in the monitor 5, for example, adjusting the image acquisition parameters, configuring microscope parameters, viewing sample images acquired by the camera, naming and renaming image files, etc.

In the smart photo-microscope system according to the invention, the camera 4 is the control interface of the whole system by having the built-in processor 3, and is used to control and integrate parameters of various parts of the whole system. The camera 4 including the built-in processor 3 is smart enough to retrieve necessary information from the microscope 7 and send desired control commands to the microscope 7. For example, it can read out relevant information such as magnification from the microscope 7 so as to provide the acquired image with a scale bar automatically. The camera 4 may also be configured to acquire a multi-channel fluorescence image and/or a single-channel fluorescence image. The photo-microscope system can detect the positional information of the reflector encoder so as to switch on the laser with a corresponding wavelength. When a color camera is used and one chooses to acquire a fluorescence image, the camera can switch automatically from RBG mode to B/W mode; and the system can automatically give the acquired B/W image a “false” color. The camera 4 may obtain information from the whole system and stores it with the acquired image in the Metadata. The images and information can be viewed, set and modified in the monitor 5 in connection with the camera 4.

In order to further facilitate user operations, as shown in FIG. 2, the smart photo-microscope system according to the invention may further include a USB hub 9, one side of which is connected to the camera and the other side of which may be connected with a mouse and/or a keyboard 10 to control the camera 4 and/or microscope 7 in cooperation with the monitor 5 having the OSD system. The mouse and/or keyboard 10 may be connected with the USB hub 9 through USB cables or Bluetooth adaptors. Moreover, the USB hub 9 may be connected with a storage device, such as a USB drive 11 for storing images or data, and/or WIFI adaptors, so as to extend functions of the whole photo-microscope system. Moreover, the mouse and/or keyboard and/or storage device may also be connected with the smart photo-microscope system via other means than the USB hub 9.

According to the first embodiment of the invention described above, the camera is able to smartly interact with the microscope by having the built-in processor 3. As compared with the prior art, it is not necessary to provide the microscope with an additional separate computer and additional software, so that the costs can be saved. Also, the footprint of the system is reduced by having no separate computer, so that it is suitably applied within limited space, and meanwhile the ease of use and convenience of the photo-microscope system are improved.

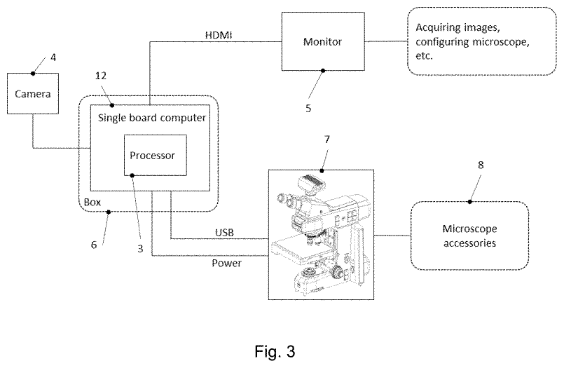

FIG. 3 shows a schematic block diagram of the smart photo-microscope system according to a second embodiment of the invention. The second embodiment differs from the first embodiment merely in that the built-in processor 3 is mounted in a single board computer (SBC) 12 instead of the camera 4. The SBC 12 is connected with both the microscope 7 and camera 4 to receive and process information from the microscope 7 and/or camera 4, for example, exchange therewith information used to operate the microscope and/or camera. The SBC 12 includes one or more PCBs on which the built-in processor 3 is mounted and which may be positioned within a box 6 outside the camera and microscope or may be incorporated inside the microscope 7.

Likewise, the SBC 12 may be connected with a monitor 5 optionally having an OSD system through e.g. HDMI, so as to display the interaction between the camera and the microscope through the SBC 12 and/or display a GUI for controlling the camera and/or microscope. The user may acquire information from the microscope and/or camera or control the microscope and/or camera through the SBC 12 by performing observations or operations on the monitor 5.

The ways of connection and information exchange between the SBC 12 and the microscope 7 are the same as those adopted between the processor board of the camera and the microscope 7 in the above first embodiment. In addition, raw image data acquired by the image sensor of the camera may also be processed by the built-in processor 3 of the SBC 12 to enhance the image quality. Also, the SBC 12 may be connected with a USB hub for extending functions of the whole photo-microscope system. Besides, other features relevant to the camera, microscope and monitor that are described with reference to the above first embodiment are also applicable to the second embodiment.

In the second embodiment, various “smart features” that are integrated in the camera by the built-in processor of the camera in the first embodiment are transferred from the camera to a separate SBC. Therefore, any kinds of cameras can become a “smart camera” like that of the first embodiment as long as it is connected with the SBC. In addition, a separate SBC is convenient to arrange various interfaces to bridge with various accessories/components of the microscope, which is helpful to extend functions of the photo-microscope system. The SBC 12 may be connected with the camera 4 through various interfaces that are compatible with both of them, such as USB, Ethernet.

The SBC is greatly simplified or reduced in terms of structure, size and cost as compared to an ordinary computer (especially PC) that is connected to the photo-microscope in the prior art, and its operation requires no dedicated software. Therefore, as with the first embodiment, the smart photo-microscope system according to the second embodiment also has the advantages of lower cost, reduced space and ease of use.

While exemplary embodiments of the utility mode have been described hereinabove, various modifications and variations may be made to the embodiments disclosed herein by those skilled in the art without departing from the scope or spirit of the invention.

1. A smart photo-microscope system, comprising:
a microscope; and
a camera attached to the microscope to photograph a microscope sample, the camera including a built-in processor and an image sensor, and being connected with the microscope to receive and process information from the microscope.

2. The smart photo-microscope system according to claim 1, wherein the camera is connected with the microscope to exchange therewith information used to operate the microscope and/or camera, wherein the camera is mounted outside or inside a housing of the microscope, and wherein the built-in processor is an embedded processor.

3. (canceled)

4. (canceled)

5. The smart photo-microscope system according to claim 1, further comprising a monitor in connection with the camera, wherein the monitor includes an On-Screen-Display (OSD) system, the monitor being connected with the camera to display the interaction between the camera and the microscope and/or display a Graphic User Interface (GUI) for controlling the camera and/or microscope, wherein the OSD system is configured to set and acquire image-related parameters and/or rename image files.

6. (canceled)

7. The smart photo-microscope system according to claim 1, wherein the camera is connected with the microscope through a USB bus so as to exchange the information with the microscope and/or supply power to the camera from the microscope.

8. The smart photo-microscope system according to claim 1, wherein the information includes commands for controlling light sources and/or commands for controlling electric stage sent from the camera to the microscope and/or objective encoding information and/or reflector encoding information sent from the microscope to the camera.

9. The smart photo-microscope system according to claim 1, wherein the camera is configured to acquire magnification of the microscope, and/or an image with a scale bar, and/or a multi-channel fluorescence image and/or a single-channel fluorescence image.

10. The smart photo-microscope system according to claim 1, wherein raw image data acquired by the image sensor are processed by the built-in processor to enhance the image quality, and wherein the camera is configured to detect the contrast method used according to condenser position and/or reflector position and/or light source used of the microscope.

11. (canceled)

12. (canceled)

13. The smart photo-microscope system according to claim 1, wherein the smart photo-microscope system is further connectable with a mouse and/or a keyboard and/or a storage device, and wherein the smart photo-microscope system is connected with the mouse and/or the keyboard and/or the storage device via a USB hub.

14. (canceled)

15. The smart photo-microscope system according to claim 1, wherein the camera is configured to send an autofocus command to the microscope before an image is taken to generate a sharp camera image, and go back to the original focusing condition before the autofocus after the image is taken.

16. A smart photo-microscope system, comprising:
a microscope;
a camera attached to the microscope to photograph a microscope sample and including an image sensor; and
a single board computer (SBC) which includes a built-in processor and is connected with the microscope and camera to receive and process information from the microscope and/or camera.

17. The smart photo-microscope system according to claim 16, wherein the SBC is connected with the microscope and camera to exchange therewith information used to operate the microscope and/or camera, wherein the camera is mounted outside or inside a housing of the microscope, and wherein the built-in processor is an embedded processor.

18. (canceled)

19. (canceled)

20. The smart photo-microscope system according to claim 16, further comprising a monitor in connection with the SBC, wherein the monitor has an On-Screen-Display (OSD) system, the monitor being connected with the SBC to display the interaction between the camera and the microscope through the SBC and/or display a Graphic User Interface (GUI) for controlling the camera and/or microscope, wherein the OSD system is configured to set and acquire image-related parameters and/or rename image files.

21. (canceled)

22. The smart photo-microscope system according to claim 16, wherein the SBC is connected with the microscope through a USB bus so as to exchange the information with the microscope and/or supply power to the SBC from the microscope.

23. The smart photo-microscope system according to claim 16, wherein the information includes commands for controlling light sources and/or commands for controlling electric stage sent from the SBC to the microscope and/or objective encoding information and/or reflector encoding information sent from the microscope to the SBC.

24. The smart photo-microscope system according to claim 16, wherein the camera is configured to acquire, through the SBC, magnification of the microscope, and/or an image with a scale bar, and/or a multi-channel fluorescence image and/or a single-channel fluorescence image.

25. The smart photo-microscope system according to claim 16, wherein raw image data acquired by the image sensor are processed by the built-in processor of the SBC to enhance the image quality, and wherein the SBC is configured to detect the contrast method used according to condenser position and/or reflector position and/or light source used of the microscope.

26. (canceled)

27. (canceled)

28. The smart photo-microscope system according to claim 16, wherein the smart photo-microscope system is connectable with a mouse and/or a keyboard and/or a storage device.

29. The smart photo-microscope system according to claim 28, wherein the smart photo-microscope system is connected with the mouse and/or the keyboard and/or the storage device via a USB hub.

30. The smart photo-microscope system according to claim 16, wherein the SBC is configured to send an autofocus command to the microscope before an image is taken to generate a sharp camera image, and go back to the original focusing condition before the autofocus after the image is taken.

31. The smart photo-microscope system according to claim 16, wherein the SBC includes one or more PCBs on which the built-in processor is mounted and which are positioned within a box outside the camera and microscope or are incorporated inside the microscope.
